(19) United States
(12) Patent Application Publication
(10) Pub. No.: US 2008/0173505 A1
(43) Pub. Date: Jul. 24, 2008

(54) Wheelchair brake system

(75) Inventors: James Robert Breakwell, Baltimore, MD (US); James Veach Breakwell, Fairchace, PA (US)

Correspondence Address: WILLIAM S RAMSEY, ESQ, 5253 EVEN STAR PLACE, COLUMBIA, MD, 21044, US

(73) Assignee: Brakewell Partnership

(21) Appl. No.: 11/655,353

(22) Filed: Jan. 19, 2007

(51) Int. Cl. A61G 5/10

(52) U.S. Cl. 188/2 F

(57) ABSTRACT

An embodiment includes a brake lever, a caliper brake, brake cable, and mounting bracket which mounts the caliper brake so that a wheelchair user's assistant can control the wheelchair wheel yet does not interfere with propulsion of the wheelchair by the user by rotating the wheelrim. One embodiment bracket has integral construction with a flange for connection to the wheelchair, a web, and a shoulder for connection to the caliper brake.

### CROSS-REFERENCE(S)

Not Applicable

### STATEMENT REGARDING FEDERALLY SPONSORED RESEARCH OR DEVELOPMENT

Not Applicable.

### REFERENCE TO A “MICROFICHE APPENDIX”

Not Applicable.

### BACKGROUND

### DESCRIPTION OF RELATED ART INCLUDING INFORMATION DISCLOSED UNDER 37 CFR 1.97 AND 37 CFR 1.98

An embodiment brake assembly allows a person assisting a wheelchair user to have improved control over the movement of the wheelchair, by slowing the movement of the chair while going up or down slopes, or, through selective application of a single brake, by steering the wheelchair while it is being pushed in a forward direction. The brakes are mounted above and behind the wheel axles and do not interfere with the propulsion of a wheelchair by its user.

U.S. Pat. No. 4,204,588 discloses a wheel chair brake which is mounted in front of the wheel. The brake is mounted on a horizontal pipe component of a bracket. The brake is activated by the elbow of the wheelchair user. Two independent brakes are used.

U.S. Pat. No. 5,492,355 discloses a wheelchair brakes activated by the user. The brakes are mounted below the axle and are activated simultaneously by a single lever.

U.S. Pat. No. 6,854,754 discloses independent brakes for each wheel which are activated by a person pushing the wheelchair. The brakes are approximately over the wheel axle.

U.S. Pat. No. D516,471 discloses the design of a wheelchair brake bracket.

The foregoing examples of the related art and limitations related therewith are intended to be illustrative and not exclusive. Other limitations of the related art will become apparent to those of skill in the art upon a reading of the specification and a study of the drawings. These examples do not provide the advantages of embodiment of the present application, that of allowing enhanced control of a wheelchair by an assistant who is pushing it, while still allowing uninhibited access to the handrim for propulsion by the wheelchair user.

### BRIEF SUMMARY

The following embodiments and aspects thereof are described and illustrated in conjunction with systems, tool and methods which are meant to be exemplary and illustrative, not limiting in scope. In various embodiments, one or more of the above-described problems have been reduced or eliminated, while other embodiments are directed to other improvements.

Embodiments include a brake assembly for a wheel on a wheelchair having handles for use by an assistant in moving the wheelchair, two wheels with tires mounted on wheel rims, and handrims mounted on the wheels for propelling the wheelchair by the wheelchair user. The assembly comprises a brake lever attached to the handle,a caliper brake having brake pads capable of restricting the movement of the wheelchair by friction of the brake pads on a wheel rim, and a cable connecting the brake lever and caliper brake. A bracket is mounted to the wheelchair and to the caliper brake, the bracket mounting the caliper brake above and behind the axle of the wheel in a position which allows contact between the brake pads and wheel rim and allows access to the handrim by the user unfettered by the caliper brake and the bracket.

In embodiments bracket for a brake assembly for a wheel on a wheelchair having handles for use by an assistant in moving the wheelchair, two wheels with tires mounted on wheel rims, and handrims mounted on the wheels for propelling the wheelchair by the wheelchair user, the bracket is mounted with a front surface toward the front on the wheelchair and a rear surface toward the rear of the wheelchair. The bracket comprises a flange having top, bottom, left, and right sides, the flange having a facility for connection to the wheelchair frame. A web has top, bottom, left, and right sides, the lengths of the top and bottom sides are adequate to enable mounting of the caliper brake in a position whereby the brake pads make contact with the wheel rim adequate to retard rotation of the wheel, and the wheelchair user has access to the handrim for propelling the wheelchair by the user unfettered by the caliper brake or bracket. The flange right side is connected to the web left side, the angle between the rear surface plane of the flange and the rear surface plane of the web is between approximately 90° and approximately 180°. Finally, there is a shoulder having top, bottom, left, and right sides, the shoulder left side connected to the web right side, the angle between the rear surface plane of the shoulder and the rear surface plane of the web between approximately 180° and approximately 270°, the shoulder having a facility for connection to a caliper brake.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a perspective view of an embodiment brake assembly showing the brake lever, cable, bracket, and caliper brake attached to a wheelchair frame.

FIG. 2 is a perspective view of the rear side of an embodiment bracket.

FIG. 3 is a plan view of an embodiment bracket flange

FIG. 4 is a plan view of an embodiment bracket web.

FIG. 5. is a plan view of an embodiment bracket shoulder.

FIG. 6A is an end view of the connection between the bottom sides of the bracket web and bracket shoulder.

FIG. 6B an end view of the connection between the bottom sides of the bracket web and bracket flange.

FIG. 6C an end view of the connection between top sides of the bracket web and bracket shoulder.

FIG. 6D an end view of the connection between the top sides of the bracket flange and bracket web.

### DETAILED DESCRIPTION

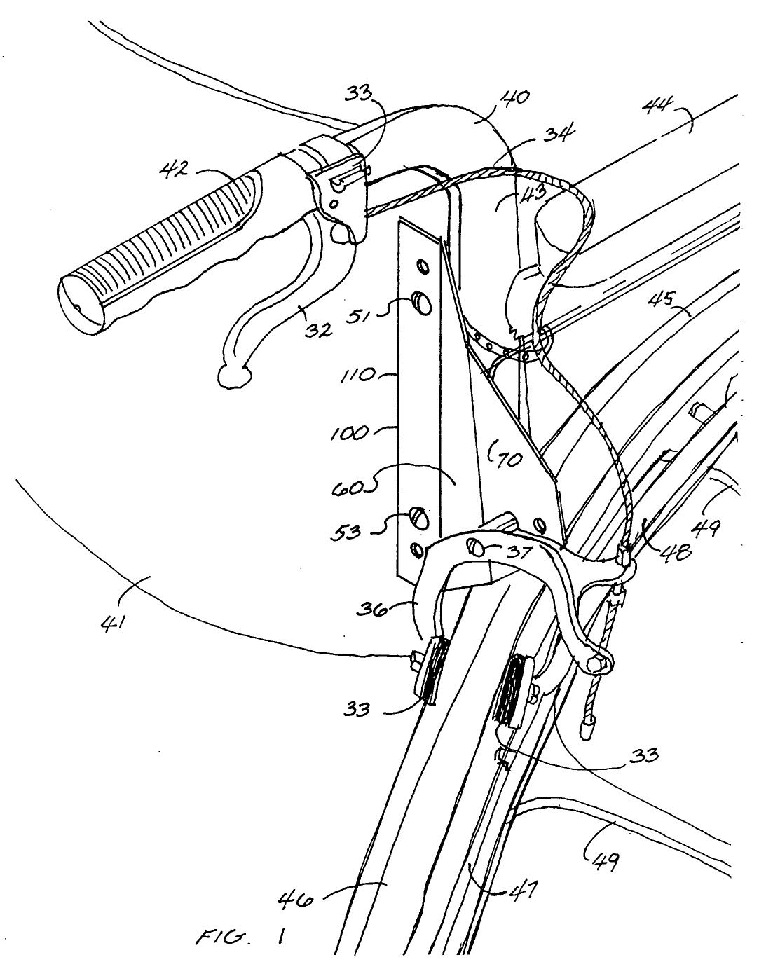

FIG. 1 is a perspective view of an embodiment brake assembly 100 showing the brake lever 32, cable 34, bracket 110, and caliper brake 36 attached to a wheelchair frame 43.

Visible in FIG. 1 is the wheelchair 40 showing the handle 42 attached to the wheelchair frame 43. The handle 42 is for use by an attendant in pushing, steering, and stopping the wheelchair. Also visible in FIG. 1 is the wheelchair back 41 attached to the frame 43. An arm support cushion 44 is provided for the user's arms and is also attached to the frame 43.

Wheelchair wheel 45 is shown comprised of spokes 49, rim 47, and tire 46 mounted on the rim 47. A handrim 48 is attached to the spokes 49. The handrim 48 is used by the wheelchair user or occupant when desired to propel the wheelchair forward or backward, selectively to steer the wheelchair, and to brake the wheelchair when the user is not assisted by an attendant.

The embodiment brake 30 shown in FIG. 1 comprises a handle assembly 32, brake cable 34, and caliper brake assembly 36. The caliper brake pads 33 bear on the wheel rim 47 and slow or stop the rotation of the wheel by friction between the pads and the rim.

The embodiment bracket 110 shown in FIG. 1 is attached by the bracket flange 50 to the wheelchair frame 43 using bolt 51 and lower bolt 53 which extend through holes in the flange and holes in the wheelchair back 41. A bracket web 60 is attached on one edge to the flange 50 and at an opposite edge to a bracket shoulder 70. The bracket has a front side closest to the front of the wheelchair and a rear side closest to the rear of the wheelchair.

The caliper brake 36 is attached by a bolt 37 to a hole in the shoulder 70. The caliper brake is oriented by the bracket so that the brake pads 33 bear on the wheel rim 47 when the brake is applied.

The embodiment bracket 110 is part of a right hand brake assembly as depicted in FIG. 1. A similar left hand brake assembly is not shown in FIG. 1 and is identical to the right hand brake assembly except the bracket of the left hand brake assembly is a mirror image of bracket 110 of FIG. 1.

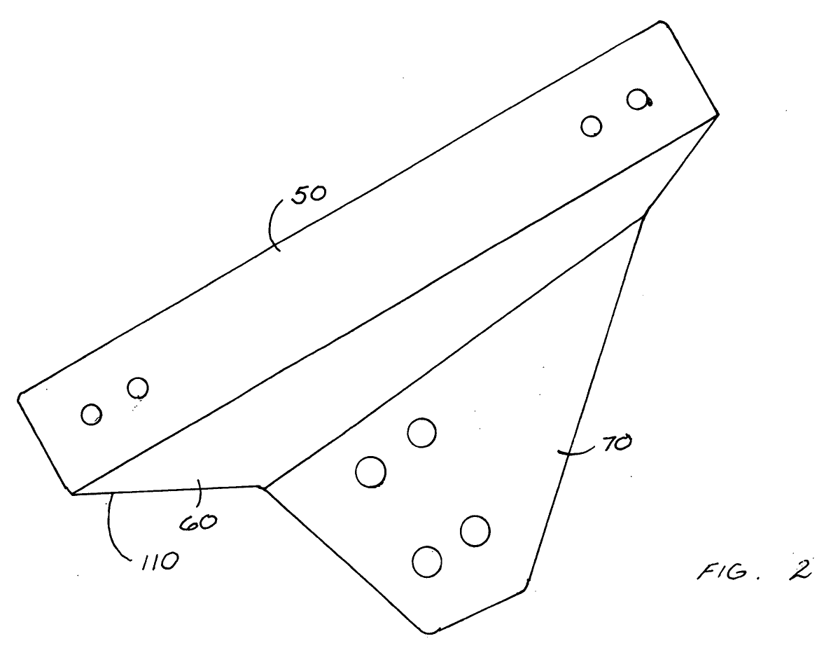

FIG. 2 is a perspective view of the rear side of an embodiment bracket 110. Visible in FIG. 2 are the flange 50, web 60, and shoulder 70. FIG. 2 represents a configuration in which flange 50 is in the plane of the paper of FIG. 2, web 60 projects from the plane on the paper out toward the reader, and shoulder 70 is above the plane of the paper of FIG. 2.

In some embodiments the flange 50, web 60 and shoulder 70 are integral and are constructed from one piece of material which is bent. In other embodiments the flange, web and shoulder are separate pieces of material which are attached by welding, bolting, fusing or adhering.

FIG. 3 is a plan view of an embodiment bracket flange 50. This embodiment has four sides, top side 58, bottom side 56, left side 52, and right side 54. Attachment facilities for attaching the flange to the wheelchair, in this embodiment holes which receive bolts or screws for attachment to the wheelchair frame, 82, 84, 86, and 88 are arrayed approximately along the center of the flange.

One embodiment flange 50 has the following approximate dimensions: top side 58, ⅞ inch; bottom side 56, ⅞ inch; left side 52, 7 inches; and right side 54, 7 inches. The dimensions will vary accordingly to the dimension of the specific wheelchairs to which the brake is attached.

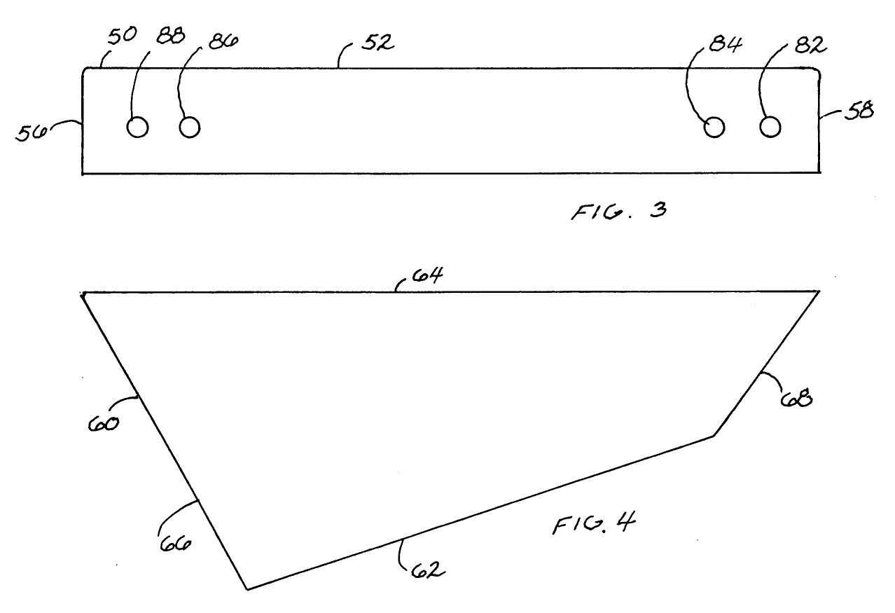

FIG. 4 is a plan view of an embodiment bracket web 60. This embodiment has four sides, top side 68, bottom side 56, left side 64, and right side 62. The left side 64 is attached to the right side 54 of the flange 50.

One embodiment web 60 has the following approximate dimensions: top side 68, 1½ inch; bottom side 66, 3 inches; left side 64, 7 inches; and right side 62, 5 inches. The dimensions will vary accordingly to the dimension of the specific wheelchairs to which the brake is attached. In particular, the top side 68 and bottom side 66 and right side 62 will vary as necessary to accomplish two objectives of the bracket, to mount the caliper brake above and behind the wheel axle so that the user's hand does not come into contact with the caliper brake when propelling the wheelchair using the handrim (48 in FIG. 1), and to mount the caliper brake in the correct orientation to insure contact of the brake pads (33 in FIG. 1) with the wheel rim (47 in FIG. 1).

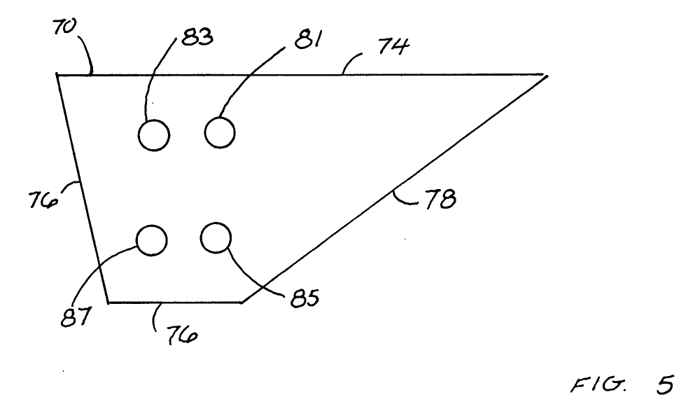

FIG. 5. is a plan view of an embodiment bracket shoulder 70. This embodiment has four sides, top side 78, bottom side 76, left side 74 and right side 76. The left side 74 is attached to the right side 62 of the web 60. Attachment facilities for attaching the caliper brake (36 in FIG. 1), in this embodiment holes which receive a bolt (37 in FIG. 1) for attachment to the caliper brake, 81, 83, 85, and 87 are arrayed in a rectangular orientation on the shoulder.

One embodiment shoulder 70 has the following approximate dimensions: top side 78, 4 inches; bottom side 76, 2¼ inches; left side 74, 5 inches; and right side 76, 1¼ inches. The dimensions will vary accordingly to the dimension of the specific wheelchairs to which the brake is attached. The dimensions will vary accordingly to the dimension of the specific wheelchairs to which the brake is attached. In particular, the top side 78, bottom side 76, left side 74 and right side 76 will vary as necessary to accomplish the objectives of the bracket described with respect to FIG. 4.

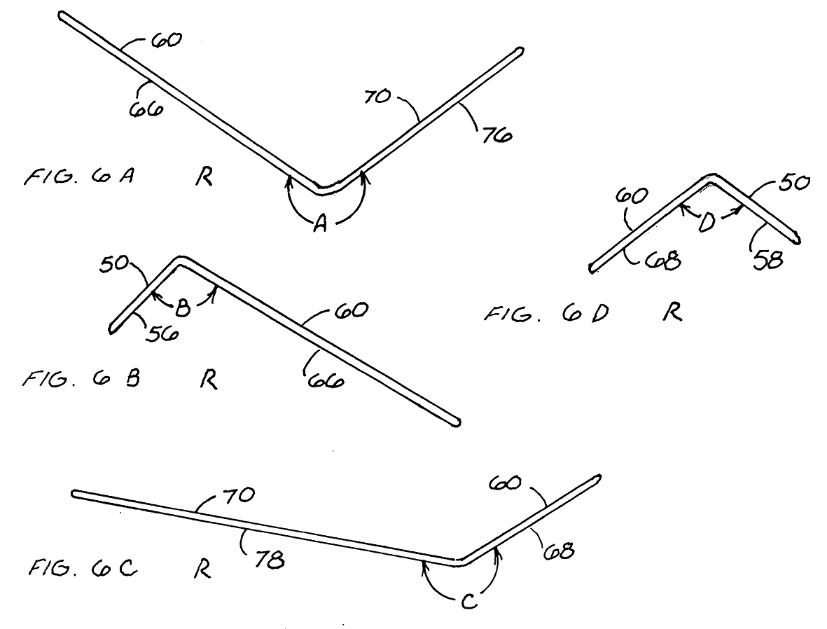

FIG. 6A is an end view of the connection between the bottom sides of the bracket web and bracket shoulder. The R indicates the rear side of the bracket. In one embodiment illustrated in FIG. 6A the angle between the web 60 and the shoulder 70 taken at the bottom sides 66 and 76, respectively, and viewed from the rear is approximately 247.5°. In other embodiments the angle may vary from approximately 180° to approximately 270° as necessary to meet the objectives described with respect to FIG. 4.

FIG. 6B is an end view of the connection between the bottom sides of the bracket web and bracket flange. The R indicates the rear side of the bracket. In one embodiment illustrated in FIG. 6B the angle between the web 60 and the flange 50 taken at the bottom sides 66 and 56, respectively, and viewed from the rear is approximately 112.5°. In other embodiments the angle may vary from approximately 90° to approximately 180° as necessary to meeting the objectives described with respect to FIG. 4.

FIG. 6C is an end view of the connection between top sides of the bracket web and bracket shoulder. The R indicates the rear side of the bracket. In one embodiment illustrated in FIG. 6C the angle between the shoulder 70 and the web 60 taken at the top sides 78 and 68, respectively, and viewed from the rear is approximately 247.5°. In other embodiments the angle may vary from approximately 180° to approximately 270° as necessary to meet the objectives described with respect to FIG. 4.

FIG. 6D is an end view of the angle between the top sides of the bracket web and flange. The R indicates the rear side of the bracket. In one embodiment illustrated in FIG. 6D the angle between the web 60 and the flange 50 taken at the top sides 68 and 58, respectively, and viewed from the rear is approximately 112.5°. In other embodiments the angle may vary from approximately 90° to approximately 180° as necessary to meet the objectives described with respect to FIG. 4.

Any suitable strong brake lever capable of mounting on the wheelchair handle can be used. Bicycle levers for upright (mountain) handlebars are suitable and are used in some embodiments. One embodiment uses BRL37 DIACOMPE Power Control 11 Levers which may be obtained from Harris Cyclery, West Newton, Mass.

Any suitable strong brake cable may be used to connect the lever and caliper brake. Bicycle cables are suitable and are used in some embodiments. One embodiment uses Jagwire/Quality Stainless Slick premium brake cables which may be obtained from Harris Cyclery, West Newton, Mass.

Any suitable strong caliper brake can be used. Bicycle caliper brakes are suitable and are used in some embodiments. One embodiment uses Odyssey 1999 Extra Long Reach Caliper brakes which may be obtained from Harris Cyclery, West Newton, Mass.

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope.

We claim:

1. A brake assembly for a wheel on a wheelchair having handles for use by an assistant in moving the wheelchair, two wheels with tires mounted on wheel rims, and handrims mounted on the wheels for propelling the wheelchair by the wheelchair user comprising:
a brake lever attached to the handle,
a caliper brake having brake pads capable of restricting the movement of the wheelchair by friction of the brake pads on a wheel rim,
a cable connecting the brake lever and caliper brake, and
a bracket mounted to the wheelchair and to the caliper brake, the bracket mounting the caliper brake above and behind the axle of the wheel in a position which allows contact between the brake pads and wheel rim and allows access to the handrim by the user unfettered by the caliper brake and the bracket.

2. The brake assembly of claim 1 wherein the bracket is mounted to the wheelchair by two bolts.

3. The brake assembly of claim 1 wherein the shoulder is mounted to the caliper brake by one bolt.

4. The brake assembly of claim 1 wherein the flange is attached to the wheelchair frame.

5. A bracket for a brake assembly for a wheel on a wheelchair having handles for use by an assistant in moving the wheelchair, two wheels with tires mounted on wheel rims, and handrims mounted on the wheels for propelling the wheelchair by the wheelchair user, the bracket mounted with a front surface toward the front on the wheelchair and a rear surface toward the rear of the wheelchair, the bracket comprising:
a flange having top, bottom, left, and right sides, the flange having a facility for connection to the wheelchair frame,
a web having top, bottom, left, and right sides,
the lengths of the top and bottom sides adequate to enable mounting of the caliper brake in a position whereby the brake pads make contact with the wheel rim adequate to retard rotation of the wheel, and the wheelchair user has access to the handrim for propelling the wheelchair by the user unfettered by the caliper brake or bracket,
the flange right side connected to the web left side, the angle between the rear surface plane of the flange and the rear surface plane of the web between approximately 90° and approximately 180°,
a shoulder having top, bottom, left, and right sides,
the shoulder left side connected to the web right side, the angle between the rear surface plane of the shoulder and the rear surface plane of the web between approximately 180° and approximately 270°, the shoulder having a facility for connection to a caliper brake.

6. The bracket of claim 5 wherein the flange, web, and shoulder are integral.

7. The bracket of claim 5 wherein the flange or shoulder are attached to the web by welding, bolting, fusing, or adhering.

8. The bracket of claim 5 wherein the angle formed by rear surface of the flange and the rear surface of the web is approximately 112.5°.

9. The bracket of claim 5 wherein the angle formed by the rear surface plane of the shoulder and the rear surface plane of the web is approximately 247.5°.

10. The bracket of claim 5 wherein the bracket is manufactured of steel, iron, aluminum, or polymer.

11. The bracket of claim 7 wherein the facility for connection of the flange to the wheelchair is a hole in the flange.

12. The bracket of claim 7 wherein the facility for connection of the shoulder to the caliper brake is a hole in the shoulder.
